(19) United States
(12) Patent Application Publication
(10) Pub. No.: US 2022/0161730 A1
(43) Pub. Date: May 26, 2022

(54) LUGGAGE COMPARTMENT STRUCTURE OF VEHICLE

(71) Applicant: KABUSHIKI KAISHA TOYOTA JIDOSHOKKI, Kariya-shi (JP)

(72) Inventors: Katsuhito FURUSAWA, Aichi-ken (JP); Hirotaka Inaba, Aichi-ken (JP)

(73) Assignee: KABUSHIKI KAISHA TOYOTA JIDOSHOKKI, Kariya-shi (JP)

(21) Appl. No.: 17/518,089

(22) Filed: Nov. 3, 2021

(30) Foreign Application Priority Data
Nov. 26, 2020 (JP) 2020-196239

(51) Int. Cl. B60R 5/04

(52) U.S. Cl. CPC B60R 5/048

(57) ABSTRACT

A luggage compartment structure of a vehicle includes a base, a support, and a deck board. The base is fixed to a vehicle body. The support is attached to the base so as to be slidable in a front-rear direction of the vehicle body. The deck board is slidable in the front-rear direction of the vehicle body with respect to the support. The deck board includes a board body attached to the support so as to be slidable in the front-rear direction of the vehicle body, and a folded portion connected to a rear end portion of the board body so as to be pivotable about an axis along a vehicle width direction of the vehicle body. The folded portion is folded down with respect to the board body in a state where the deck board is pulled out from a luggage compartment.

### CROSS-REFERENCE TO RELATED APPLICATION

This application claims priority to Japanese Patent Application No. 2020-196239 filed on Nov. 26, 2020, the entire disclosure of which is incorporated herein by reference.

### BACKGROUND ART

The present disclosure relates to a luggage compartment structure of a vehicle.

As the luggage compartment structure of a vehicle, for example, a luggage floor device described in Japanese Patent Application Publication No. 2003-341431 is known. The luggage floor device described in Japanese Patent Application Publication No. 2003-341431 is disposed in a rear portion of a vehicle body of a vehicle. The luggage floor device includes a luggage floor provided so as to be substantially flush with a floor surface of a luggage compartment, and a floor support means that supports the luggage floor to be swingable in a vertical direction and to be slidable in a horizontal direction. The floor support means includes a pair of guide rails separated in a vehicle width direction.

However, the above-described conventional technique has the following problems. That is, in a place where a space behind the vehicle is relatively narrow, workability at the time of loading and unloading luggage into and from the luggage compartment is relatively poor. In addition, regardless of the size of the space behind the vehicle, workability behind the vehicle at the time of loading and unloading luggage into and from an inner part of the luggage compartment is relatively poor.

The present disclosure is directed to providing a luggage compartment structure of a vehicle capable of improving workability behind the vehicle at the time of loading and unloading luggage into and from a luggage compartment.

### SUMMARY

In accordance with an aspect of the present disclosure, a luggage compartment structure of a vehicle includes a base, a support, and a deck board. The base is fixed to a vehicle body. The support is attached to the base so as to be slidable in a front-rear direction of the vehicle body. The deck board is slidable in the front-rear direction of the vehicle body with respect to the support. The deck board includes a board body attached to the support so as to be slidable in the front-rear direction of the vehicle body, and a folded portion connected to a rear end portion of the board body so as to be pivotable about an axis along a vehicle width direction of the vehicle body. The folded portion is folded down with respect to the board body in a state where the deck board is pulled out from a luggage compartment.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a perspective view illustrating a luggage compartment structure of a vehicle according to a first embodiment of the present disclosure;

FIG. 2 is a perspective view illustrating a state in which a deck board illustrated in FIG. 1 is pulled out from a luggage compartment;

FIG. 3 is an exploded perspective view of the luggage compartment structure illustrated in FIG. 1;

FIG. 4 is a cross-sectional view of the luggage compartment structure illustrated in FIG. 3;

FIGS. 5A and 5B are perspective views each illustrating an unlocking mechanism for unlocking a support from a base;

FIGS. 6A and 6B are side views each illustrating a state in which the deck board illustrated in FIG. 4 is pulled out from the luggage compartment;

FIG. 7 is a rear view illustrating a luggage compartment structure of a vehicle according to a second embodiment of the present disclosure;

FIG. 8 is a simplified cross-sectional view of the luggage compartment structure illustrated in FIG. 7;

FIG. 9 is a perspective view illustrating a state in which the deck board illustrated in FIG. 7 is pulled out from the luggage compartment; and

FIGS. 10A to 10C are simplified cross-sectional views each illustrating a state in which the deck board illustrated in FIG. 8 is pulled out of the luggage compartment.

### DETAILED DESCRIPTION OF THE EMBODIMENTS

Hereinafter, embodiments of the present disclosure will be described in detail with reference to the drawings. In the drawings, the same or equivalent elements are denoted by the same reference numerals, and redundant description will be omitted.

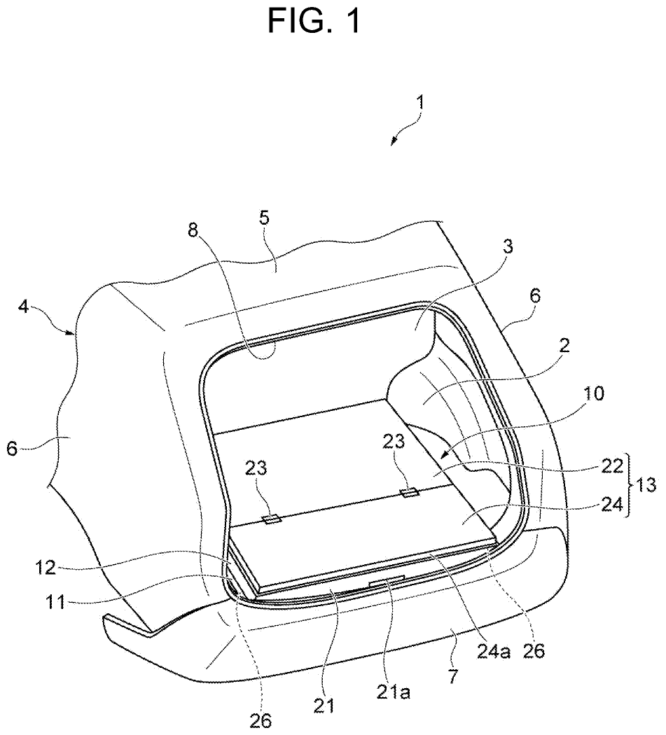

FIG. 1 is a perspective view illustrating a luggage compartment structure of a vehicle according to a first embodiment of the present disclosure. In FIG. 1, a vehicle 1 includes a luggage compartment 2 on which a luggage is loaded. The luggage compartment 2 is disposed in a region on the rear side of a seat 3 in the vehicle 1.

The vehicle 1 includes a vehicle body 4. The vehicle body 4 is provided with a roof panel 5 on its upper portion and a side panel 6 on each side portion thereof. The vehicle body 4 has an opening 8 defined by the roof panel 5, the side panels 6, and a rear bumper 7 in its rear end portion. The opening 8 is opened and closed by a back door (not illustrated).

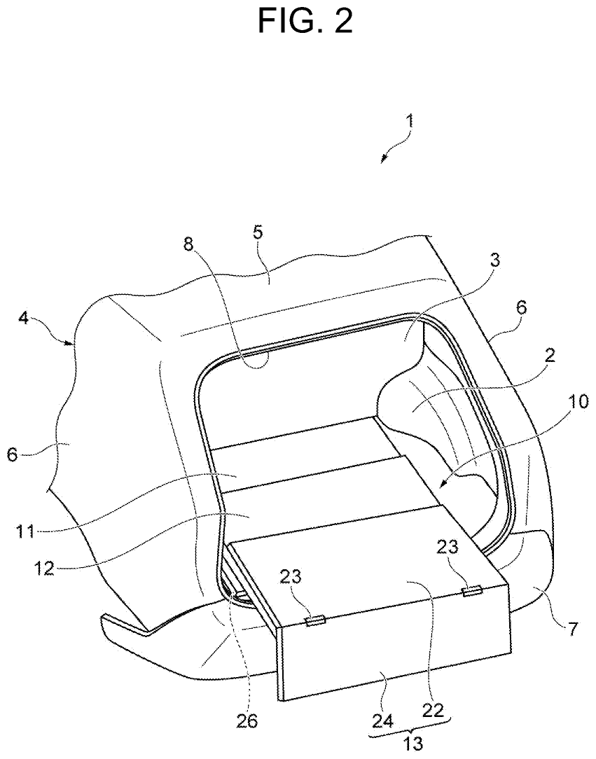

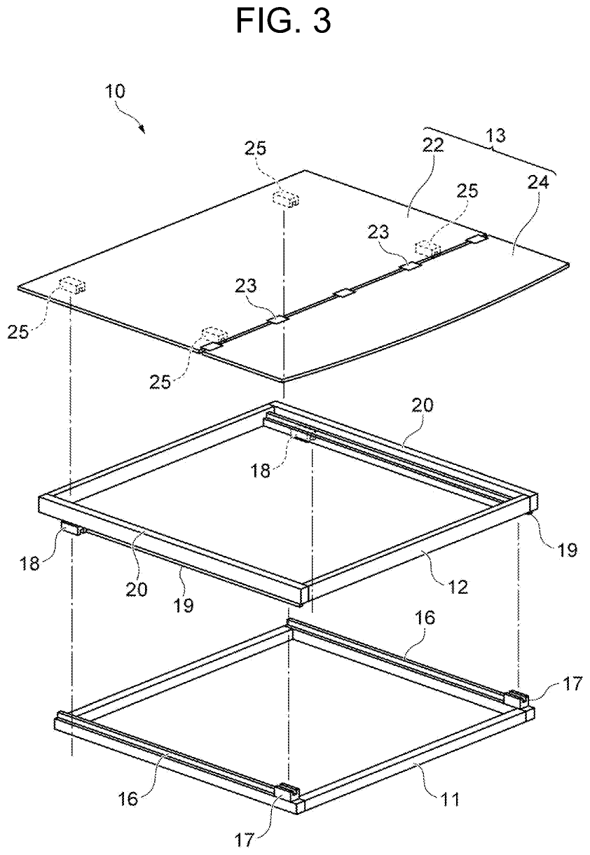

As illustrated in FIGS. 1 to 3, a luggage compartment structure 10 of the present embodiment includes a frame-shaped base 11, a frame-shaped support 12 slidable in a front-rear direction of the vehicle body 4 with respect to the base 11, and a deck board 13 slidable in the front-rear direction of the vehicle body 4 with respect to the support 12. FIG. 2 illustrates a state in which the deck board 13 illustrated in FIG. 1 is pulled out from the luggage compartment 2. FIG. 3 is an exploded perspective view of the luggage compartment structure 10 illustrated in FIG. 1.

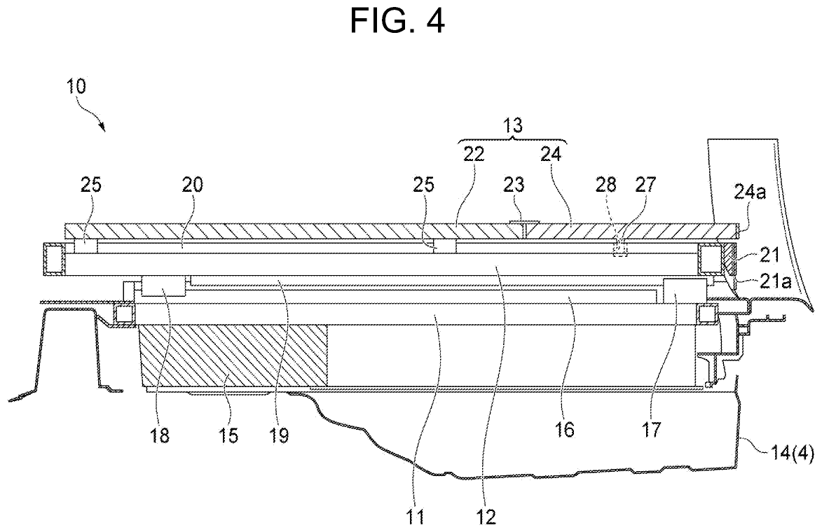

The base 11 is fixed to the vehicle body 4. As illustrated in FIG. 4, for example, the base 11 is attached to a frame 14 of the vehicle body 4 via a bracket 15. Rails 16 extending in the front-rear direction of the vehicle body 4 are provided in the respective upper portions on both the right and left sides of the base 11. Further, slide blocks 17 adjacent to the rails 16 are provided in the respective upper portions of the rear end portions on both the right and left sides of the base 11.

The support 12 is attached to the base 11 so as to be slidable in the front-rear direction of the vehicle body 4. Slide blocks 18 to be fitted to the rails 16 of the base 11 are provided in the respective vicinities of the front end portions of the lower portions on both the right and left sides of the support 12. The slide blocks 18 are slidable along the respective rails 16. Further, rails 19 extending in the front-rear direction of the vehicle body 4 are provided adjacent to the respective slide blocks 18 in the lower portions on both the right and left sides of the support 12. The slide blocks 17 of the base 11 are fitted to the respective rails 19 and slidable along the rails 19. Therefore, the support 12 is slidably supported on the base 11 via the slide blocks 17 and 18. Rails 20 extending in the front-rear direction of the vehicle body 4 are provided in the respective upper portions on both the right and left sides of the support 12.

The support 12 has a rubber handle cover 21 attached to its rear end surface. The handle cover 21 corresponds to a cushioning member. The handle cover 21 has a cutout portion 21a opened downward in a center portion in a vehicle width direction thereof. In FIG. 3, the handle cover 21 is omitted for convenience.

The deck board 13 includes a board body 22 attached to the support 12 so as to be slidable in the front-rear direction of the vehicle body 4, and a folded portion 24 connected to the rear end portion of the board body 22 via a plurality of hinges 23 so as to be pivotable about an axis along the vehicle width direction of the vehicle body 4.

Slide blocks 25 to be fitted to the rails 20 of the support 12 are provided on the front side and the rear side of the lower portions on both the right and left sides of the board body 22. The slide blocks 25 are slidable along the rails 20. Therefore, the board body 22 is slidably supported by the support 12 by the four slide blocks 25.

The folded portion 24 is formed of one plate. The folded portion 24 is folded down with respect to the board body 22 in a state where the deck board 13 is pulled out from the luggage compartment 2. The folded portion 24 has a rubber member 24a as a cushioning member attached to its rear end surface. In FIG. 3, the rubber member 24a is omitted for convenience.

The deck board 13 is larger in width than the base 11 and the support 12. The width is a dimension in the vehicle width direction of the vehicle body 4. The deck board 13 has, for example, a width sufficient to cover deck sides 26 on both the right and left sides fixed to the frame 14 of the vehicle body 4. This prevents an article from falling onto the bottom of the luggage compartment 2.

As illustrated in FIG. 4, the folded portion 24 of the deck board 13 has a lock pin 27 on each of the right and left sides so as to lock the deck board 13 to the support 12 when the deck board 13 is stored in the luggage compartment 2 together with the support 12. The support 12 has a pin hole 28 on each of the right and left sides so as to allow the lock pin 27 to be inserted thereinto.

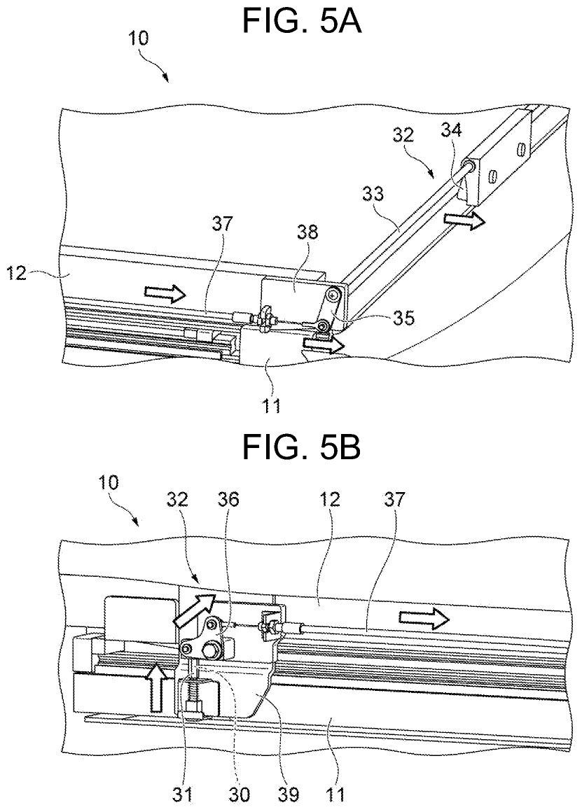

As illustrated in FIGS. 5A and 5B, the support 12 is provided with a lock pin 30 on each of the right and left sides so as to lock the support 12 to the base 11. The base 11 is provided with a plurality of sets of pin receivers 31 on both the right and left sides so as to allow the lock pin 30 to be inserted thereinto. As a result, when the deck board 13 is stored in the luggage compartment 2 together with the support 12 and when the deck board 13 is pulled out to the rear side from the luggage compartment 2 together with the support 12, the support 12 is locked to the base 11.

As illustrated in FIGS. 5A and 5B, the support 12 is provided with an unlocking mechanism 32 for unlocking the support 12 from the base 11. The unlocking mechanism 32 includes a shaft 33 pivotably supported by the support 12, a handle 34 integrated with the shaft 33, I-shaped cranks 35 connected to both ends of the shaft 33, L-shaped cranks 36 fixed to the lock pins 30, and cables 37 connecting the cranks 35 and 36.

The shaft 33 extends in the vehicle width direction. The shaft 33 is supported by a bracket 38 attached to the support 12. The handle 34 is integrated with the shaft 33 in its center portion in the vehicle width direction. The crank 35 is pivotably supported by the bracket 38. The shaft 33 is connected to the upper ends of the cranks 35. One end of each cable 37 is connected to the lower end of the corresponding crank 35. The other end of each cable 37 is connected to one end of the corresponding crank 36.

Each crank 36 is pivotably supported by a bracket 39 attached to the base 11. Each lock pin 30 is fixed to the corresponding crank 36 so as to protrude below the crank 36. The pin receiver 31 into which each lock pin 30 is inserted is provided in the bracket 39.

In the unlocking mechanism 32, when the handle 34 is operated, the shaft 33 rotates to pivot the cranks 35, and the cables 37 are pulled toward the rear of the vehicle body 4 (see arrows in FIG. 5A). Then, each crank 36 pivots, and the corresponding lock pin 30 rises and comes out of the pin receiver 31 (see arrows in FIG. 5B). As a result, the base 11 and the support 12 are unlocked.

In the luggage compartment structure 10 configured as described above, the support 12 and the deck board 13 are normally stored in the luggage compartment 2 as illustrated in FIG. 1. When the support 12 and the deck board 13 are slid toward the rear of the vehicle body 4 from such a stored state, the deck board 13 is pulled out from the luggage compartment 2 to the rear side of the vehicle body 4 together with the support 12 as illustrated in FIG. 2.

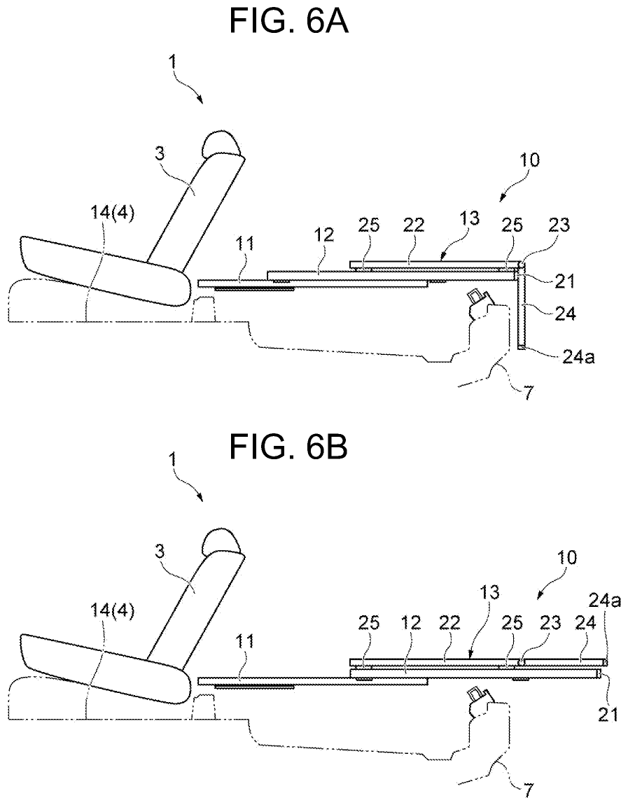

At this time, the deck board 13 can be switched between a folded mode (first mode) and a flat mode (second mode). As illustrated in FIG. 6A, the folded mode is a mode in which the folded portion 24 is folded downward with respect to the board body 22 in a state where the deck board 13 is pulled out from the luggage compartment 2. As illustrated in FIG. 6B, the flat mode is a mode in which the folded portion 24 is disposed in a flat state on the support 12 in a state where the deck board 13 is pulled out from the luggage compartment 2.

When the deck board 13 is used in the folded mode, a hand is put in the cutout portion 21a of the handle cover 21 to grip the handle 34, and the support 12 is slid toward the rear of the vehicle body 4 with respect to the base 11 in a state where the base 11 and the support 12 are unlocked. At this time, the support 12 is slid until the rear end of the support 12 is positioned behind the rear bumper 7.

The folded portion 24 of the deck board 13 is lifted and the lock pin 27 is removed from the pin hole 28, whereby the deck board 13 is slid toward the rear of the vehicle body 4 with respect to the support 12 in a state where the support 12 and the deck board 13 are unlocked. At this time, the deck board 13 is slid until the rear end of the board body 22 of the deck board 13 is positioned behind the support 12. As a result, the folded portion 24 of the deck board 13 pivots downward with respect to the board body 22 by its own weight to be folded down.

When the folded portion 24 is folded down with respect to the board body 22, the folded portion 24 contacts the handle cover 21. However, since the rear end of the support 12 is positioned behind the rear bumper 7, the folded portion 24 covers the rear bumper 7 without contacting the rear bumper 7. Therefore, the rear bumper 7 is protected by the folded portion 24.

When the deck board 13 is used in the flat mode, the support 12 is slid toward the rear of the vehicle body 4 with respect to the base 11 together with the deck board 13 in the state where the base 11 and the support 12 are unlocked in the same manner as in the folded mode. At this time, the folded portion 24 of the deck board 13 is supported by the support 12 and maintained in a flat state.

As described above, in the present embodiment, behind the vehicle 1, when luggage is loaded and unloaded into and from the luggage compartment 2, the support 12 is slid toward the rear of the vehicle body 4 with respect to the base 11, and the deck board 13 is slid toward the rear of the vehicle body 4 with respect to the support 12, whereby the deck board 13 is pulled out from the luggage compartment 2. At this time, the deck board 13 is slid until the folded portion 24 of the deck board 13 is located behind the support 12, whereby the folded portion 24 pivots downward with respect to the board body 22 and is folded downward. In this state, the distance from the position on the most rear side (outer side) of the deck board 13 to the position on the most front side (inner side) of the deck board 13 is shortened. Therefore, loading and unloading of luggage into and from the inner part of the luggage compartment 2 are facilitated. In addition, even in a place where a space behind the vehicle 1 is relatively narrow, loading and unloading of luggage into and from the luggage compartment 2 are facilitated. As a result, workability behind the vehicle 1 at the time of loading and unloading luggage into and from the luggage compartment 2 is improved. In addition, when loading and unloading relatively heavy objects into and from the luggage compartment 2, it is possible to reduce a burden on a waist of an operator.

In the present embodiment, the deck board 13 can be switched between the folded mode in which the folded portion 24 is folded down with respect to the board body 22 in the state where the deck board 13 is pulled out from the luggage compartment 2 and the flat mode in which the folded portion 24 is disposed on the support 12 in the state where the deck board 13 is pulled out from the luggage compartment 2. When the deck board 13 is used in the flat mode, the deck board 13 is pulled out from the luggage compartment 2 by sliding the support 12 integral with the deck board 13 toward the rear of the vehicle body 4 with respect to the base 11. Therefore, versatility is expanded, for example, the deck board 13 can be used as a table in an outdoor scene such as camping.

In the present embodiment, the folded portion 24 is formed of one plate. This simplifies the structure of the deck board 13 and reduces the cost of the luggage compartment structure 10.

In the present embodiment, the rubber handle cover 21 is attached to the rear end surface of the support 12, and the rubber member 24a is attached to the rear end surface of the folded portion 24 of the deck board 13. Therefore, even if the folded portion 24 contacts the support 12 and the rear bumper 7 when the folded portion 24 is folded down with respect to the board body 22, the support 12 and the rear bumper 7 are prevented from being damaged.

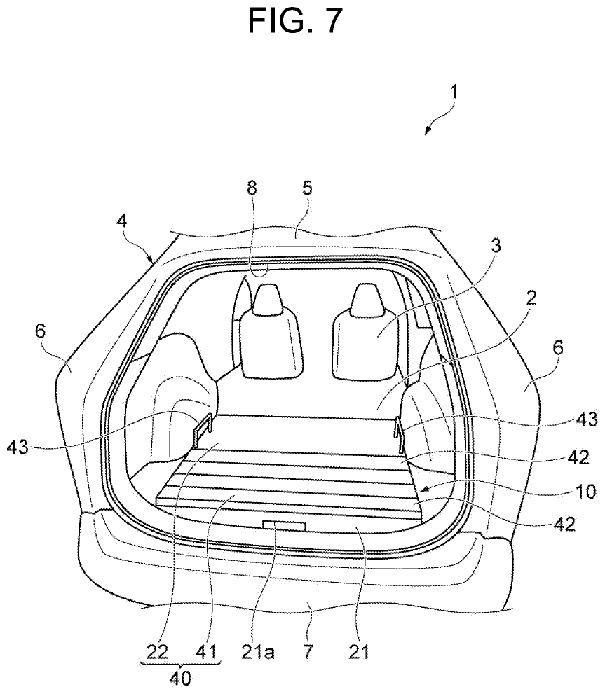

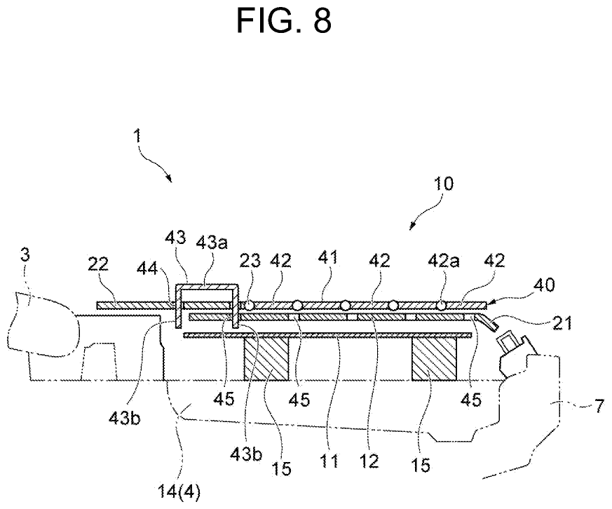

FIG. 7 is a rear view illustrating a luggage compartment structure of a vehicle according to a second embodiment of the present disclosure. FIG. 8 is a simplified cross-sectional view of the luggage compartment structure illustrated in FIG. 7. In FIGS. 7 and 8, the luggage compartment structure 10 of the present embodiment includes the base 11, the support 12, and a deck board 40.

The deck board 40 includes the board body 22 and a folded portion 41 connected to the rear end portion of the board body 22 via the hinges 23 so as to be pivotable about an axis along the vehicle width direction of the vehicle body 4. The folded portion 41 has a structure (for example, a caterpillar structure) in which a plurality of (here, five) shoe plates 42 arrayed in the front-rear direction of the vehicle body 4 are pivotably connected to each other via shafts 42a.

The board body 22 of the deck board 40 is detachably provided with a U-shaped locking handle 43 on each of the right and left sides thereof in order to lock the deck board 40 with respect to the support 12. Each handle 43 has a grip 43a and two legs 43b extending downward from both ends of the grip 43a. The board body 22 has lock holes 44 in its rear portion to allow the legs 43b of the handle 43 to be inserted.

The support 12 has a plurality of sets of lock holes 45 on both the right and left sides so as to allow the legs 43b of the handle 43 to be inserted thereinto. The plurality of sets of lock holes 45 are disposed along the front-rear direction of the vehicle body 4. When the legs 43b of the handle 43 are inserted into the lock holes 44 in the board body 22 and the lock hole 45 in the support 12, the deck board 40 and the support 12 are locked.

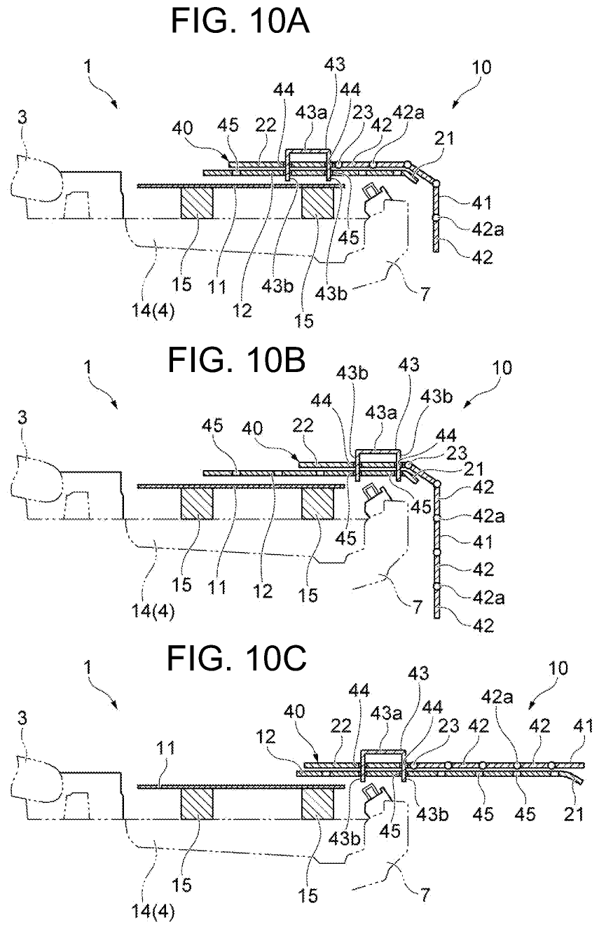

Here, since the plurality of sets of lock holes 45 are provided in the support 12 along the front-rear direction of the vehicle body 4, not only when the support 12 and the deck board 40 are stored in the luggage compartment 2, but also when the support 12 and the deck board 40 are pulled out from the luggage compartment 2, the deck board 40 and the support 12 can be locked regardless of the amount of the deck board 40 pulled out (see FIGS. 10A to 10C). In FIGS. 8 and 10A to 10C, the number and positions of the lock holes 45 do not coincide with each other for convenience.

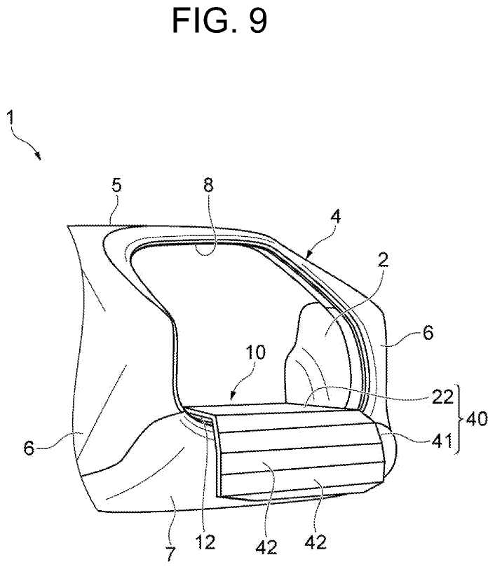

When the deck board 40 is slid toward the rear of the vehicle body 4 together with the support 12 from the state where the support 12 and the deck board 40 are stored in the luggage compartment 2, the deck board 40 is pulled out from the luggage compartment 2 together with the support 12 as illustrated in FIG. 9.

At this time, the deck board 40 can be switched between the folded mode and the flat mode as in the first embodiment. As illustrated in FIGS. 10A and 10B, the folded mode is a mode in which the folded portion 41 is folded down with respect to the board body 22 in the state where the deck board 40 is pulled out from the luggage compartment 2. As illustrated in FIG. 10C, the flat mode is a mode in which the folded portion 41 is disposed on the support 12 in the state where the deck board 40 is pulled out from the luggage compartment 2.

When the deck board 40 is used in the folded mode, the support 12 is slid toward the rear of the vehicle body 4 with respect to the base 11 with the handle 43 being held by hand, in the state where the base 11 and the support 12 are unlocked. The legs 43b of the handle 43 are removed from the lock holes 45 by lifting the handle 43, whereby the deck board 40 is slid toward the rear of the vehicle body 4 with respect to the support 12 while the handle 43 is held, in a state where the support 12 and the deck board 40 are unlocked. As a result, the folded portion 41 of the deck board 40 pivots downward with respect to the board body 22 to be folded down.

At this time, since the support 12 and the deck board 40 are slid while the handle 43 is held by hand, the support 12 and the deck board 40 can be smoothly and easily slid in the front-rear direction of the vehicle body 4.

The folded portion 41 has a structure in which the plurality of shoe plates 42 are pivotably connected to each other via the shaft 42a. Therefore, as illustrated in FIGS. 10A and 10B, the amount of the deck board 40 pulled out can be finely adjusted according to the dimensions of the luggage and the like.

When the amount of the deck board 40 pulled out is relatively small, only the shoe plates 42 positioned on the rear side of the folded portion 41 are folded down, and the shoe plates 42 positioned on the front side of the folded portion 41 are disposed on the support 12. As the amount of the deck board 40 pulled out increases, the number of shoe plates 42 that are folded down increases, and the number of shoe plates 42 disposed on the support 12 decreases.

In the present embodiment, the handle cover 21 attached to the rear end surface of the support 12 is disposed to be tilted with respect to the support 12. Therefore, one shoe plate 42 is tilted and folded down along with the handle cover 21. However, the handle cover 21 may be disposed in a flat state with respect to the support 12 as in the first embodiment.

When the deck board 40 is used in the flat mode, the support 12 is slid toward the rear of the vehicle body 4 with respect to the base 11 together with the deck board 40 with the handle 43 held by hand, in the state where the base 11 and the support 12 are unlocked. At this time, the folded portion 41 of the deck board 40 is supported by the support 12 to be in a flat state.

The second embodiment also improves workability behind the vehicle 1 at the time of loading and unloading luggage into and from the luggage compartment 2.

In the present embodiment, the folded portion 41 of the deck board 40 has a structure in which the plurality of shoe plates 42 are pivotably connected to each other. Therefore, the amount of the deck board 40 pulled out can be changed in accordance with the size of the luggage and the like. In addition, even in the place where the space behind the vehicle 1 is relatively narrow, the deck board 40 can be relatively easily pulled out from the luggage compartment 2.

The present disclosure is not limited to the above embodiments. For example, in the second embodiment, the folded portion 41 of the deck board 40 may have a rubber member (cushioning member) attached to its rear end surface.

In the first embodiment, the board body 22 of the deck board 13 may be detachably provided with a handle for locking the deck board 13 with respect to the support 12.

In the above embodiments, the rubber handle cover 21 which is a cushioning member is attached to the rear end surface of the support 12, but the cushioning member is not particularly limited to a rubber member such as the rubber handle cover 21, and may be a soft resin member or the like. The same applies to the cushioning members attached to the rear end surfaces of the folded portions 24 and 41.

What is claimed is:

1. A luggage compartment structure of a vehicle, comprising:
a base fixed to a vehicle body;
a support attached to the base so as to be slidable in a front-rear direction of the vehicle body; and
a deck board slidable in the front-rear direction of the vehicle body with respect to the support,
wherein the deck board includes a board body attached to the support so as to be slidable in the front-rear direction of the vehicle body, and a folded portion connected to a rear end portion of the board body so as to be pivotable about an axis along a vehicle width direction of the vehicle body, and
the folded portion is folded down with respect to the board body in a state where the deck board is pulled out from a luggage compartment.

2. The luggage compartment structure of the vehicle according to claim 1, wherein the deck board is switchable between a first mode in which the folded portion is folded down with respect to the board body in a state where the deck board is pulled out from the luggage compartment and a second mode in which the folded portion is disposed on the support in a state where the deck board is pulled out from the luggage compartment.

3. The luggage compartment structure of the vehicle according to claim 1, wherein the folded portion is formed of one plate.

4. The luggage compartment structure of the vehicle according to claim 1, wherein the folded portion has a structure in which a plurality of shoe plates arrayed in the front-rear direction of the vehicle body are pivotably connected to each other.

5. The luggage compartment structure of the vehicle according to claim 1, wherein cushioning members are attached to respective rear end surfaces of the support and of the folded portion of the deck board.
